(19) United States
(12) Patent Application Publication
(10) Pub. No.: US 2026/0370142 A1
(43) Pub. Date: Nov. 19, 2026

(54) VOLTAGE CONVERTER WITH POWER MODE AWARE FEATURE

(71) Applicant: Ambiq Micro, Inc., Austin, TX (US)

(72) Inventors: Peter Schaeffer, Austin, TX (US); Ivan Bogue, Austin, TX (US); David Sawey, Austin, TX (US)

(21) Appl. No.: 19/678,654

(22) Filed: May 15, 2026

Related U.S. Application Data
(60) Provisional application No. 63/806,433, filed on May 15, 2025.

(51) Int. Cl. H02M 3/156; H02M 1/00

(52) U.S. Cl. CPC H02M 3/156; H02M 1/0016; H02M 1/0032

(57) ABSTRACT

An adaptive voltage converter is provided. The adaptive voltage converter includes a voltage output circuit operable to providing a voltage output at different voltage levels. The adaptive voltage converter includes a voltage controller coupled to the voltage output circuit. The voltage controller includes a mode input receiving a power mode signal. The voltage controller is operable to control the voltage output circuit to provide a voltage output specific to the received operating power mode.

### CROSS-REFERENCE TO RELATED APPLICATIONS

This application claims the benefit of and priority to U.S. Provisional Application No. 63/806,433, filed May 15, 2025, which is hereby incorporated by reference herein in its entirety.

### TECHNICAL FIELD

The present invention relates generally to voltage converters. More specifically, a voltage converter that may be adapted to a power mode is disclosed.

### BACKGROUND

In recent years, due to the growth of portable electronics, there has been a push to decrease the power used by microcontrollers (or “MCU”), microprocessors, application processors, digital signal processors (DSPs), neural processing units (NPUs), and other circuits used in portable electronic appliances. With lower power requirements, effective electronics operation time can be extended, or alternatively, smaller batteries can be used. Commonly, the power consumption of a microcontroller and associated circuits may be reduced by using a lower supply voltage, or by reducing the amount of internal capacitance being charged and discharged during the operation of the circuit.

One method for reducing microcontroller power relies on hardware or software-based power mode switching. Power modes can be selected for microcontroller components or resources based on operating state, operating conditions, and/or sleep cycle characteristics and other factors to configure low power modes for selected microcontroller components at the time the processor enters a low power or sleep state. In some systems, a set of predefined low power configurations can be used, while more sophisticated systems can dynamically select low power configurations to maximize power savings while still meeting system latency requirements.

A typical system-on-chip (SoC) will support multiple operating modes to achieve different power and performance trade-offs. For example, a microcontroller system might have a shut down mode in which all circuits and memories are powered down, a deep sleep mode in which most circuits are powered down except for critical memories and watchdog circuits, a sleep mode in which circuits remain powered up but clocks are gated, a low power active mode in which clock frequencies are lower and supply voltages are lower, and a high performance active mode in which clock frequencies are higher and supply voltages are commensurately higher.

It is critical to have an adaptive voltage converter that can deliver regulated supply voltages across these various operating modes. As the SoC changes between operating modes, an adaptive voltage converter will generally need to provide different voltage levels. For example, a supply voltage for a processor core may be delivered at 0.8V in a high performance active mode, 0.5V in a low power active mode, and 0.4V in a deep sleep mode. It is desirable for this adaptation to occur automatically.

### SUMMARY

The term embodiment and like terms, e.g., implementation, configuration, aspect, example, and option, are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings, and each claim.

According to certain aspects of the present disclosure, an adaptive voltage converter is provided. The adaptive voltage converter includes a voltage output circuit operable to providing a voltage output at different voltage levels. The adaptive voltage converter further includes a voltage controller coupled to the voltage output circuit. The voltage controller includes a mode input receiving a power mode signal. The voltage controller is operable to control the voltage output circuit to provide a voltage output specific to the received operating power mode.

According to certain aspects of the present disclosure, a method of operating an adaptive voltage converter is provided. The method includes receiving, by a voltage controller of the adaptive voltage converter, a power mode signal. The method further includes determining, by the voltage controller, a voltage level associated with the power mode signal. The method further includes causing, by the voltage controller, a voltage output circuit of the adaptive voltage converter to provide the voltage level.

### BRIEF DESCRIPTION OF THE DRAWINGS

The disclosure will be better understood from the following description of exemplary embodiments together with reference to the accompanying drawings, in which:

FIG. 1 is a diagram of a system on chip in an energy efficient device requiring near threshold voltages for various components;

FIG. 2 is a block diagram of the example system on chip in FIG. 1;

FIG. 3 is a block diagram of an example voltage converter that automatically adapts to different power modes;

FIG. 4 illustrates a sub-system architecture of the example voltage converter of FIG. 3 for adjusting comparator parameters, according to some implementations of the present disclosure;

FIG. 5 illustrates a sub-system architecture for adjusting a charging time for the example voltage converter of FIG. 3, according to some implementations of the present disclosure;

FIG. 6 illustrates a sub-system architecture for adjusting a power switch of the example voltage converter of FIG. 3, according to some implementations of the present disclosure;

FIG. 7 illustrates a sub-system architecture for reducing power consumption in a power converter, according to some implementations of the present disclosure;

FIG. 8 is a graph showing inductor current through an off-chip inductor of a converter, according to some implementations of the present disclosure;

FIG. 9 is a graph showing a method of switching from a lower power mode to a higher power mode, according to some implementations of the present disclosure; and

FIG. 10 is a graph showing a method of switching from a higher power mode to a lower power mode, according to some implementations of the present disclosure.

The present disclosure is susceptible to various modifications and alternative forms. Some representative embodiments have been shown by way of example in the drawings and will be described in detail herein. It should be understood, however, that the invention is not intended to be limited to the particular forms disclosed. Rather, the disclosure is to cover all modifications, equivalents, and alternatives falling within the spirit and scope of the invention as defined by the appended claims.

### DETAILED DESCRIPTION

The present inventions can be embodied in many different forms. Representative embodiments are shown in the drawings, and will herein be described in detail. The present disclosure is an example or illustration of the principles of the present disclosure, and is not intended to limit the broad aspects of the disclosure to the embodiments illustrated. To that extent, elements, and limitations that are disclosed, for example, in the Abstract, Summary, and Detailed Description sections, but not explicitly set forth in the claims, should not be incorporated into the claims, singly, or collectively, by implication, inference, or otherwise. For purposes of the present detailed description, unless specifically disclaimed, the singular includes the plural and vice versa; and the word “including” means “including without limitation.” Moreover, words of approximation, such as “about,” “almost,” “substantially,” “approximately,” and the like, can be used herein to mean “at,” “near,” or “nearly at,” or “within 3-5% of,” or “within acceptable manufacturing tolerances,” or any logical combination thereof, for example.

The present disclosure is directed toward an adaptive voltage converter in which settings are updated automatically as a load circuit transitions between various power and performance modes.

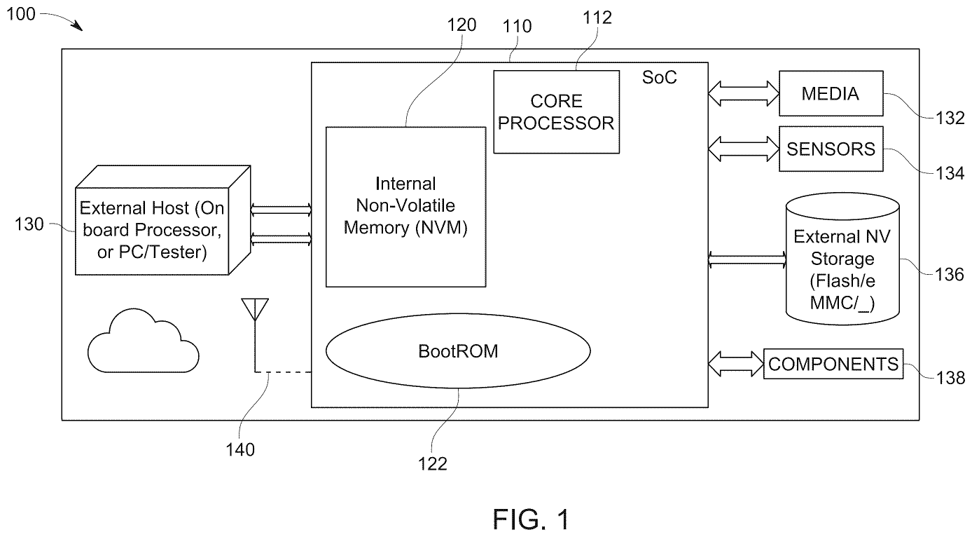

FIG. 1 shows a block diagram of a device 100 with a low power microcontroller system, according to certain aspects of the present disclosure. The low power microcontroller system can be implemented as a system on chip 110, as represented in FIG. 1. In some implementations, the low power microcontroller system is implemented as multiple discrete systems or components on a common board. The system on chip 110 includes a core processor 112 and non-volatile memory 120. The core processor 112 includes at least one microcontroller (MCU), central processing unit (CPU), digital signal processor (DSP), neural processing unit (NPU), or any combination thereof. The non-volatile memory 120 can be a magneto-resistive RAM (MRAM). The system on chip 110 also includes other memories such as a read only memory (ROM) 122, volatile memories like static random access memory (SRAM), and so on. In some implementations, the system on chip 110 is installed in the device 100 and the core processor 112 executes applications generally stored in the non-volatile memory 120 to operate the device 100 to perform different functions.

The device 100 may include an external host processor 130 that controls the functions of the system on chip 110. The external host processor 130 may be connected via wired interfaces such as Universal Asynchronous Receiver Transmitter (UART), Serial Parallel Interface (SPI), or inter-integrated circuit (I2C) interfaces. The system on chip 110 controls and accesses a set of components on the device 100 that may include media devices 132 such as a display or an audio output, sensors 134, a non-volatile (NV) memory device 136 such as Multi-bit SPI (MSPI) Flash or embedded MultiMediaCard (eMMC), or other components 138. In some implementations, the NV memory device 136 serves as an alternate storage device for storing a recovery image. The host processor 130 can be coupled to a wireless interface 140 such as Bluetooth or WiFi that allows communication with external components to the device 100. In some implementations, a battery 150 provides power to the components of the device 100 including the system on chip 110.

Although not all of the electronic components illustrated in FIG. 1 may be operable in the sub-threshold or near-threshold domains in any particular embodiment, some, at least, may be advantageously adapted to do so, with concomitant reductions in system power dissipation.

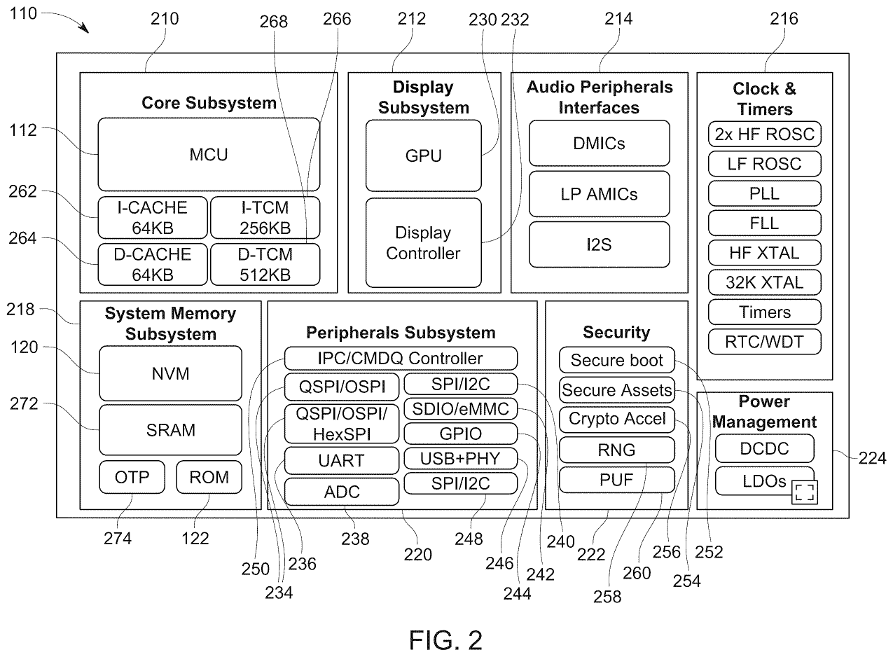

FIG. 2 shows a block diagram of the system on chip 110 in FIG. 1, according to certain aspects of the present disclosure. The system on chip 110 includes a core subsystem 210, a display subsystem 212, an audio peripherals interface subsystem 214, a clock and timers subsystem 216, a system memory subsystem 218, a peripheral subsystem 220, a security subsystem 222, and/or a power management subsystem 224. In some implementations, one or more of the subsystems in FIG. 2 are not required. For example, in some implementations, the display subsystem 212, the audio peripherals interface subsystem 214, and the security subsystem 222 can be omitted or provided outside the system on a chip 110. For example, one or more of these subsystems can be provided in the host processor 130. In some implementations, functions associated with one or more of these subsystems can be distributed between the host processor 130 and the system on a chip 110.

The display subsystem 212 includes a graphics processing unit (GPU) 230 and a display controller 232 to drive displays on the device 100. In some implementation, the GPU 230 is a 2.5D GPU supporting vector acceleration and the display controller 232 is an LCD controller. In some implementations, the display controller 232 supports one or more interfaces including Octal SPI (OSPI), Memory in Pixel (MiP) display interface, and/or MIPI display serial interface (DSI).

The audio peripherals interface subsystem 214 includes different audio peripheral interfaces for driving audio components on the device 100. In some implementations, the audio peripheral interfaces include a digital microphone (DMIC) interface supporting pulse density modulation (PDM), a low power always-on audio analog to digital converter (ADC) for supporting an analog microphone (AMIC) input, full-duplex multichannel inter-integrated circuit sound (I2S) interfaces, I2S interfaces supporting Asynchronous Sample Rate Conversion (ASRC), and so on.

The clocking and timers subsystem 216 includes timers and clocks for the system on chip 110. The clock subsystem 216 can include at least one high frequency RC oscillator (HF ROSC), low frequency RC oscillator (LF ROSC), phase locked loop (PLL), frequency locked loop (FLL), high frequency crystal oscillators (HF XTAL), 32 kHz crystal oscillator (32K XTAL), timer, real time clock (RTC), or watchdog timer (WDT).

The peripheral subsystem 220 includes different interfaces such as Quad SPI (QSPI)/OSPI/HexSPI interfaces 234, UART interfaces 236, analog to digital converters 238, SP/I2C master interfaces 240, SDIO (Secure Digital Input Output)/MMC (Multi-Media card) interfaces 242, a set of general purpose input/output (GPIO) pins 244, a USB interface 246, and a SPI/I2C slave interface 248. The peripheral interfaces are managed by a peripheral controller 250 that manages inter process communication (IPC) and a command queue (CMDQ). The security subsystem 222 includes a secure boot 252, security assets 254, a crypto accelerator 256, a random number generator (RNG) 258 and a physical unclonable function (PUF) 260. The power management subsystem 224 includes power sources such as low drop out (LDO) and DC power regulator supply sources.

The core subsystem 210 includes the core processor 112 that may be any suitable processor, microcontroller, and the like. In this example, the core processor 112 is an ARM Cortex MCU, but any suitable programmable controller or processor may be used. The core subsystem 210 includes an instruction cache 262 and a data cache 264. The core subsystem 210 includes an instruction tightly controlled memory (TCM) 266 and a data TCM 268. The system memory subsystem 218 includes a static random access memory (SRAM) 272, a one-time programmable (OTP) device 274, and the read only memory (ROM) 122. In this example, the SRAM is a synchronous SRAM (SSRAM), and the OTP device 274 is an electronic fuse (eFuse). The OTP device 274 stores data such as trim values that may written during production testing and is read by the core processor 112 for tuning components such as an example adaptable voltage converter. The system memory subsystem 218 also includes the non-volatile memory 120, which is MRAM in this example.

The power management subsystem 224 includes the example adaptable voltage converter that automatically changes output to accommodate different power modes for the system on chip. The power management subsystem 224 provides voltage to both digital modules such as the core subsystem 210 and analog modules such as the clocking and timers subsystem 216 and analog to digital converters (“ADC”) in the peripheral subsystem 220, and the like. The power management subsystem 224 includes reference voltage generators and reference current generators. The reference voltage generator and reference current generator are each common modules for supplying a stable reference signal to analog modules on the chip 110. The reference voltage generator is sometimes used to derive the output reference current provided by reference current generator.

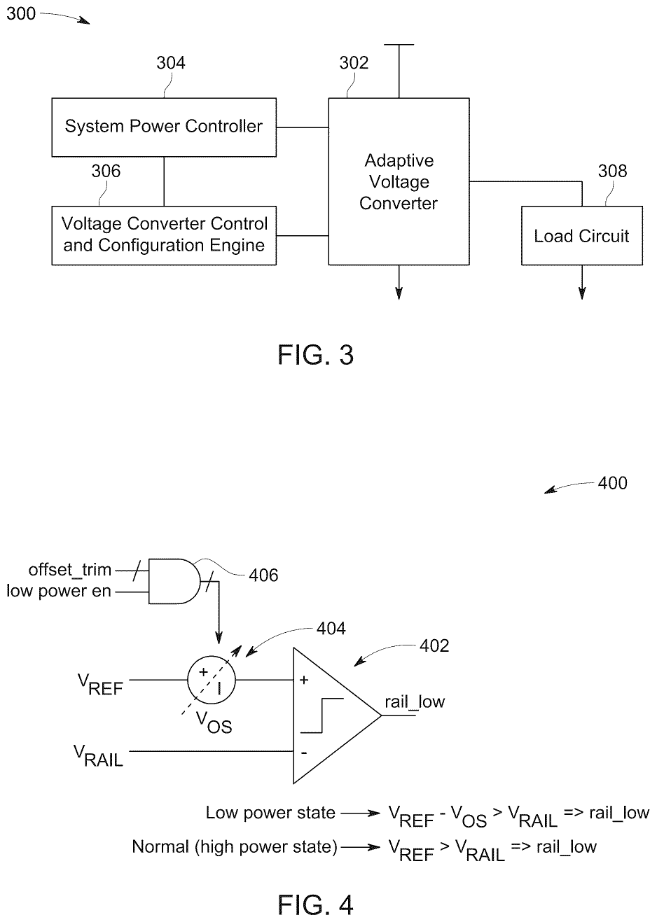

FIG. 3 is a system 300 for adaptive voltage conversion, according to some implementations of the present disclosure. The system 300 includes an example adaptive voltage converter 302 that can automatically adjust voltage level and/or other configuration values based on a system operating mode. The adaptive voltage converter 302 can be in the DCDC portion of the power management 224. The system 300 includes a system power controller 304 that sets the system operating mode. Portions of the system power controller 304 can be provided in the MCU 112, core subsystem 210, and/or digital state machines of the system on chip 110. In some implementations, the system operating mode includes, for example, a standby mode, a deep sleep mode, a low power active mode, a high performance active mode, etc. The system power controller 304 sends out power mode control signals to other blocks in an overall system (e.g., the system on chip 110 of FIG. 1).

The system power controller 304 can send out power mode control signals to both the adaptive voltage converter 302 and a voltage converter control and configuration engine 306 coupled to the adaptive voltage converter 302. The voltage converter control and configuration engine 306 can be provided in the MCU 112, core subsystem 210, digital state machines of the system on chip 110 and/or the DCDC portion of the power management 224. Upon receiving notification of a change in system operating mode, the voltage converter control and configuration engine 306 and the adaptive voltage converter 302 may adjust the output voltage of the adaptive voltage converter 302 accordingly. This output voltage is provided to the load circuit 308. The load circuit 308 can include analog and/or digital subsystems of the system on chip 110 (e.g., the system memory subsystem 218, the peripherals subsystem 220, the clock and timers subsystem 216, the security subsystem 222, the core subsystem 210, the system memory subsystem 218, the audio peripheral interface subsystem 214, etc.). In some cases, the adaptive voltage converter 302 is a voltage output circuit. In some cases, the voltage output circuit is a switching converter.

In some implementations, the system 300 can also change other characteristics of the adaptive voltage converter 302 to based on an objective. For example, a variety of tunable configurations can impact power efficiency of the adaptive voltage converter 302, and the variety of tunable configurations may change from one system operating mode to another system operating mode. As an example, in a buck converter using a pulse frequency modulation (PFM) scheme, it would be desirable to adjust the on-time of the PMOS power switch (TON) automatically when switching from one operating mode to another. In a deep sleep mode, the desired TON time may be short (e.g., 100 ns-200 ns). In a low power active mode, the power delivery needs to be increased compared to the deep sleep mode, so the desired TON time may be longer (e.g., two times to three times longer). In a high performance active mode, the power delivery needs to be increased further, so the desired TON time may be longer yet (e.g., four times to six times longer). Thus, when the system on chip 110 transitions between any two of these modes, the system power controller 304 can signal to the voltage converter control and configuration engine 306 that a system operating mode change is underway. The voltage converter control and configuration engine 306 can adjust TON automatically to the value that is suitable for the target operating mode.

One or more other characteristics of the adaptive voltage converter 302 may be adapted when transitioning between modes. These characteristics include, for example, comparator trip points, comparator offset values, current drive capabilities, power switch size, oscillator frequencies, converter type (e.g., switching from a buck converter to an LDO or vice versa), and converter operating mode (e.g., constant current mode vs. discrete current mode). In some implementations, in an LDO implementation, amplifier bandwidth can be adjusted based on different modes of operation.

In some implementations, comparator trip points, comparator offset values, and/or adjustable output voltages can be adapted according to FIG. 4. FIG. 4 illustrates a sub-system architecture 400 that can be implemented in the system 300, according to some implementations of the present disclosure. In some implementations, the sub-system architecture 400 is provided in the adaptive voltage converter 302 and/or the voltage converter control and configuration engine 306. The sub-system architecture 400 includes a comparator 402, a variable voltage supply 404, and a low power logic 406. The low power logic 406 is used to generate control for the variable voltage supply 404. For example, when low power operation is enabled (i.e., low power en signal is asserted), the variable voltage supply 404 can generate an offset voltage V_{OS}. When low power operation is not enabled (i.e., low power en signal is deasserted), the variable voltage supply 404 can generate a voltage that is lower than the offset voltage V_{OS} or can generate a zero voltage 0V.

The voltage V_{RAIL} is generated, for example, by the output of a buck converter. The voltage V_{RAIL} represents the voltage provided by the adaptive voltage converter 302 to the load circuit 308. In some implementations, the system power controller 304 indicates that the adaptive voltage converter 302 should operate in low power operation, generating the low power en signal. The low power en signal can be provided to the voltage converter control and configuration engine 306 and/or the adaptive voltage converter 302. The variable voltage supply 404, located in either the voltage converter control and configuration engine 306 or the adaptive voltage converter 302, can be configured to generate the offset voltage V_{OS}. The offset voltage V_{OS} effectively lowers a reference voltage V_{REF} used to generate a control signal rail_low for controlling the voltage level of V_{RAIL}.

In an example, the sub-system architecture 400 implements the following behavior. In normal high power operation, the reference voltage V_{REF} is compared against the regulated output of the voltage converter V_{RAIL}. If V_{RAIL} dips below V_{REF}, then the adaptive voltage converter 302 charges up V_{RAIL}. In low power operation, the offset voltage V_{OS} is introduced to the operation of the comparator 402 to effectively lower the reference voltage V_{REF}. The effect of the offset voltage V_{OS} is that V_{RAIL} will be regulated to a lower voltage (i.e., a voltage lower than the reference voltage V_{REF}). Regulating V_{RAIL} to a voltage lower than the reference voltage V_{REF} can result in reducing power consumption of the system 300. In the sub-system architecture 400, low power operation is determined when the “low_power_en” signal is asserted. Using the sub-system architecture 400, the variable voltage supply 404 allows for controlling or adjusting comparator trip points, comparator offset values, and adjustable output voltages of voltage converters. Although one offset voltage V_{OS} is described, the value of the offset voltage V_{OS} can be adjusted according to operating power modes. For example, a standby mode, a deep sleep mode, a low power active mode, and a high performance active mode can have different associated offset voltages.

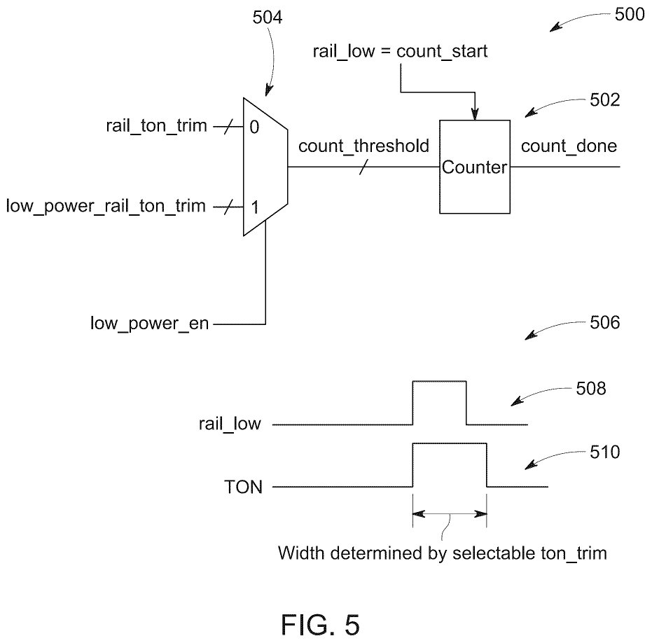

FIG. 5 provides a sub-system architecture 500 for adjusting a charging time for a voltage converter (e.g., the adaptive voltage converter 302), according to some implementations of the present disclosure. In FIG. 4, the relationship between V_{RAIL} and V_{REF} or V_{RAIL} and V_{REF}−V_{OS} is used to generate the control signal rail_low for controlling the voltage level of V_{RAIL}. The control signal rail_low, when deasserted, indicates that the voltage V_{RAIL} is at an acceptable level for the current operating mode (i.e., the reference level set by V_{REF} or V_{REF} −V_{OS}). The control signal rail_low, when asserted, indicates that the voltage V_{RAIL} has departed from the acceptable level for the current operating mode (e.g., V_{RAIL} is lower than the reference voltage V_{REF}). When the control signal rail_low is asserted, then the adaptive voltage converter 302 should charge up V_{RAIL} to the acceptable level. The sub-system architecture 500 can be used to control the charging time for charging V_{RAIL} to the acceptable level.

The sub-system architecture 500 includes a counter 502 and a multiplexer 504. The sub-system architecture 500 adjusts the time for charging by allowing a longer charging time during normal operation and a shorter charging time during low power operation. For example, the multiplexer 504 can include control signals “low_power_rail_ton_trim” and “rail_ton_trim” to indicate thresholds for the counter 502. The multiplexer 504 selects one of these thresholds as the “count_threshold” value to control when the counter 502 stops counting. The counter 502 starts counting based on the control signal rail_low. When the control signal rail_low is asserted, this indicates that the counter 502 should start counting. The counter 502 stops counting when the threshold “count_threshold” is reached. At that point, a signal “count_done” can be generated by the counter 502.

FIG. 5 also shows a graphical relationship 506 between the control signal rail_low and the charging time TON. The multiplexer 504 can be provided with multiple trim codes (e.g., one for normal high power option and one for low power option) to determine charging time or rail on-time (TON). In low power modes, a lower setting is used to achieve higher DC/DC efficiencies. For feedback stability reasons, the rail_low control signal is used to initiate charging but not used to stop charging. As shown in the graphical relationship 506, a rail_low signal graph 508 shows that the rail_low signal is asserted for a duration that is smaller than a duration of TON shown on the TON graph 510.

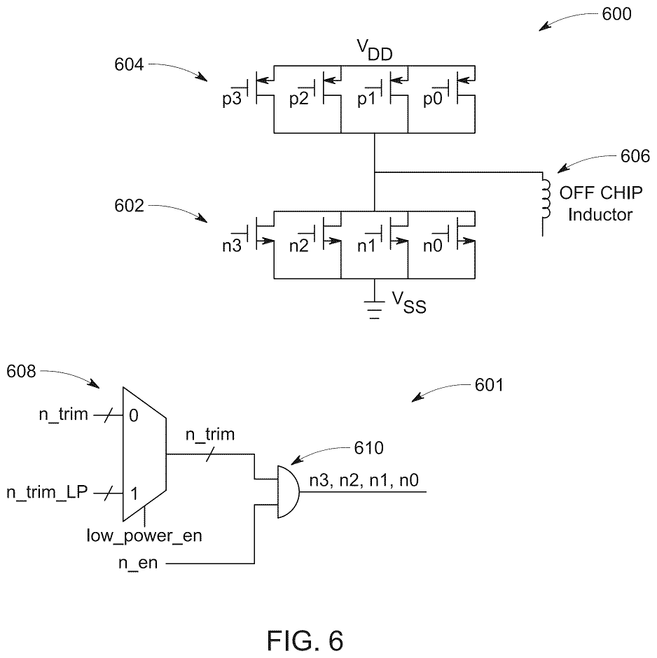

FIG. 6 illustrates a sub-system architecture 600 of a power converter and a control circuit 601 to adjust a power switch assembly of the sub-system architecture 600, according to some implementations of the present disclosure. The power switch assembly includes a group of PMOS devices 604 and a group of NMOS devices 602. The power switch assembly can be a switch stage in a buck converter. Instead of having a single PMOS device and a single NMOS device as the power switch, the power switch assembly provides the multiple PMOS and NMOS devices with each device having its unique gate controls. In the example of FIG. 6, three PMOS devices 604 are provided with unique gate controls indicated by p0, p1, p2, and p3 signals, and three NMOS devices 602 are provided with unique gate controls indicated by n0, n1, n2, and n3 signals. For example, in a buck converter, the NMOS devices 602 and PMOS devices 604 can drive an off-chip inductor 606.

The unique gate controls facilitate adjusting drive of the power switch assembly. The control circuit 601 is provided as an example of NMOS logic circuitry that can be used to generate the n0, n1, n2, and n3 signals. A similar control circuit can be used for PMOS logic for the p0, p1, p2, and p3 signals. The control circuit 601 includes a multiplexer 608 and a logic block 610. The multiplexer 608 facilitates selecting between a normal operating mode “n_trim” and a low power operation “n_trim_LP.” Based on different high power vs low power trims, which are selectable via the multiplexer controlled by “low_power_en” signal, only some of the NMOS devices 602 may be enabled during low power. Thus, the logic block 610 will provide a set of signals {n3, n2, n1, n0} for controlling the NMOS devices 602 when the power switch assembly is meant to be enabled (e.g., indicated by “n_en” signal). By reducing the number of PMOS devices 604 and/or NMOS devices 602, dynamic power consumption of charging up the capacitance associated with the power switch assembly is reduced.

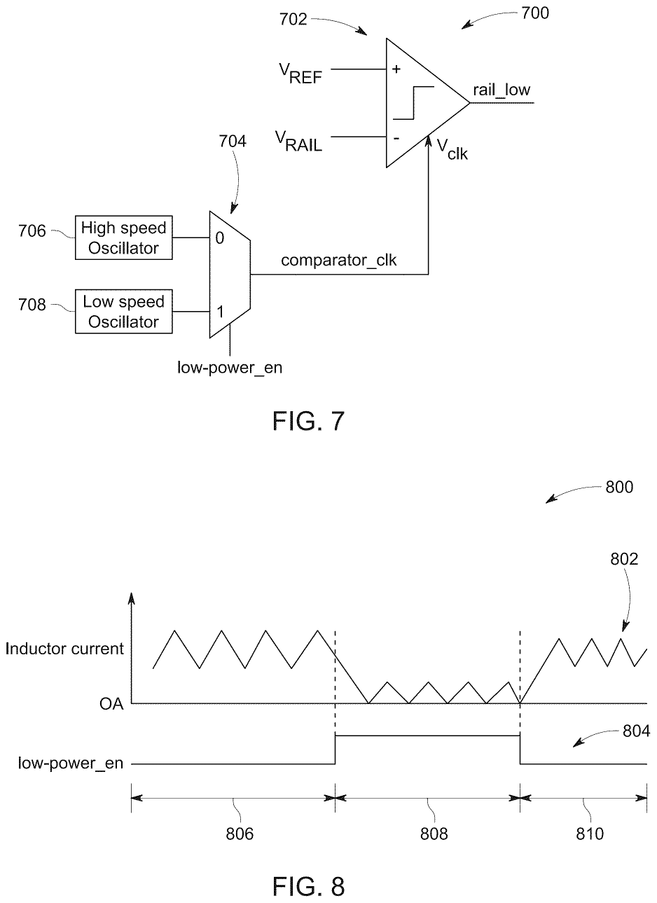

FIG. 7 illustrates a sub-system architecture 700 for reducing power consumption, according to some implementations of the present disclosure. The sub-system architecture 700 includes a comparator 702, a multiplexer 704, a high-speed oscillator 706, and a low-speed oscillator 708. The “rail_low” control signal in FIG. 7 is similar to or the same as the “rail_low” signal in FIGS. 4 and 5. A rate at which the “rail_low” signal is generated can be adjusted using the sub-system architecture 700. In alternative implementations, a rate at which the “rail_low” signal is sampled can be adjusted. The comparator 702 is a clocked comparator that uses either a faster clock (the high-speed oscillator 706) or a slower clock (the low-speed oscillator 708). Using the low_power_en signal, either the faster clock or the slower clock can be chosen as the clock for the comparator. That is, the “rail_low” signal is generated at or changes at most at the frequency of the selected clock. DC/DC can use clocked comparators (e.g., the comparator 702) to monitor rail levels. Power consumption of the comparator 702 is positively correlated with the comparator's clock frequency. In low power states, the sub-system architecture 700 can be used to lower clock rate to reduce internal power consumption of the voltage converter (e.g., a buck converter).

FIG. 8 is a graph 800 showing inductor current 802 through an off-chip inductor of a converter in different power modes, according to some implementations of the present disclosure. The graph 800 includes the inductor current 802 and the “low_power_en” signal 804 indicating whether low power operation is activated or not activated. For example, during a duration 806 and a duration 810, low power operation is not activated. During a duration 808, low power operation is activated. In some implementations durations 806 and 810 show the inductor current 802 in high power conditions. In high power conditions, the voltage converter (e.g., buck converter) can use continuous mode conduction (CCM) to achieve a lower ripple and exhibit higher efficiencies. In some implementations duration 808 show the inductor current 802 in a low power condition. In low power conditions, the voltage converter (e.g., buck converter) can automatically switch to discontinuous conduction mode (DCM), which provides efficiency enhancements at ultra light loads.

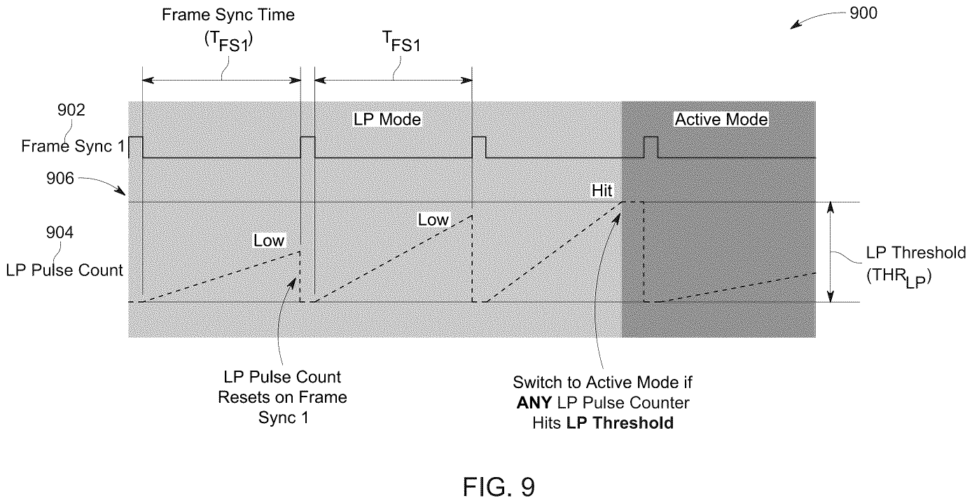

FIG. 9 is a graph 900 showing a method of switching from a lower power mode to a higher power mode, according to some implementations of the present disclosure. Using FIG. 5, as an example, the TON is time where V_{RAIL} is charged up to try to match or exceed the reference voltage V_{REF}. One or more pulses of TON may be needed to get V_{RAIL} charged to the reference voltage V_{REF}.

In FIG. 9, the graph 900 shows the number of TON pulses over time as LP pulse count 904. The time scale in the graph 900 is designated using a frame sync 1 signal 902. To stay in low power operation, the number of TON pulses should not exceed an LP threshold 906 during a period of the frame sync 1 signal 902. As shown in the graph 900, the number of TON pulses do not exceed the LP threshold 906 during the first two periods of the frame sync 1 signal 902, so the system power controller 304 indicates that the adaptive voltage converter 302 remain in low power operation. During the third period of the frame sync 1 signal 902, the number of TON pulses exceeds the LP threshold 906. At that point in time, the system power controller 304 can switch the adaptive voltage converter 302 to active mode. As shown in the graph 900, the LP pulse count 904 is reset at using the frame sync 1 signal 902.

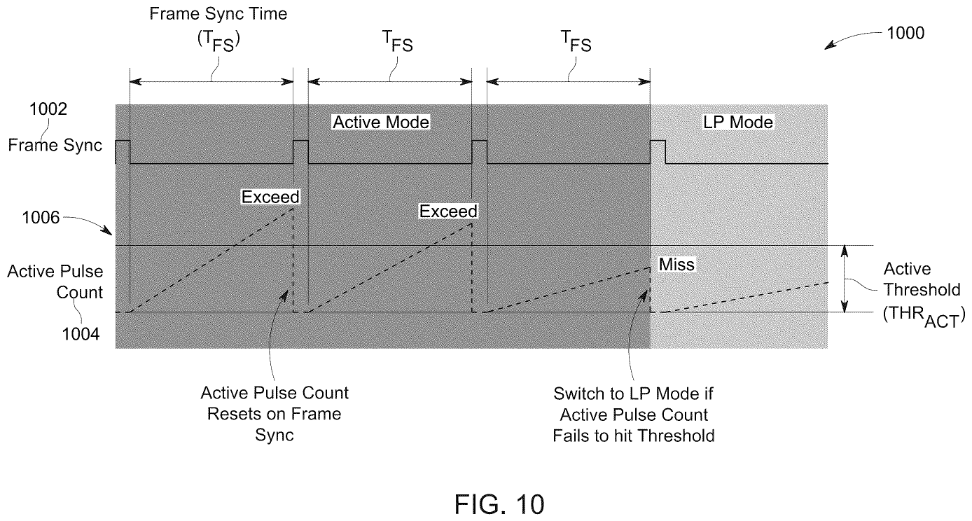

FIG. 10 is a graph 1000 showing a method of switching from a higher power mode to a lower power mode, according to some implementations of the present disclosure. The graph 1000 shows the number of TON pulses over time as active pulse count 1004. Similar to the frame sync 1 signal 902 of FIG. 9, FIG. 10 uses a frame sync 1002 to synchronize counting of the number of TON pulses over a period of time set by a period of the frame sync 1002. The graph 1000 highlights an active threshold 1006 such that if the number of TON pulses is less than the active threshold 1006, the power operating mode is switch from an active mode to a low power mode. As can be seen in the graph 1000, in the first two periods of the frame sync 1002, the active threshold 1006 is exceeded, thus allowing the system power controller 304 to remain in the active mode. However, in the third period of the frame sync 1002, the active threshold 1006 is not met, thus indicating that the system power controller 304 provide signals that indicate that the adaptive voltage converter 302 switch to low power operation.

In some implementations, the active threshold 1006 and the LP threshold 906 are different. In some implementations, the LP threshold 906 is greater than the active threshold 1006. In some implementations, the LP threshold 906 is the same as the active threshold 1006. In some implementations, the LP threshold 906 and the active threshold 1006 can be individually programmed. Although shown as single thresholds in FIGS. 9 and 10, this method of switching power operating modes can be extended to multi-threshold systems where different thresholds are set for high performance active mode, low performance active mode, sleep mode, deep sleep mode, standby mode, etc.

In some implementations, the voltage converter control and configuration engine 306 stores target configurations for each operating mode in a local memory. That local memory may be the ROM 122, the SRAM 272, flash memory, MRAM, resistive RAM (RRAM), registers, latches, synthesized logic, or any other known circuit for storing configuration values. The target configurations for each operating mode may be fixed values for all SoCs, may be tuned uniquely for all SoCs, or may be a mix of fixed and tuned values. Here, all SoCs are assumed to be manufactured on a same wafer and operating mode, and operating mode parameters can vary across the wafer, therefore, tuning values for each SoC can allow after-manufacturing adjustments. In some implementations, tuning parameter values after manufacturing can yield diminishing returns in relation to effort and cost involved in tuning the parameter values. Thus, the fixed and tuned values can be based on effort and cost. For example, since power is related to the square of voltage, there is a benefit to tuning voltage as low as possible for each particular SoC, and the lowest voltage achievable can be different from one SoC to another SoC due to process variation. In another example, oscillator frequency does not provide huge benefit with minor precision steps, as long as the value is within a right ballpark. Thus, oscillator frequency can be provided as a fixed value for a specific range. Thus in some cases, parameters that are tuned are based on a magnitude of the impact the parameters have on power in relation to other parameters.

In cases where certain target configurations change from chip to chip, the configurations can be trimmed at production time using any known measurement and trimming method. For example, process control monitor circuits could be measured to determine a process corner, and target configurations could then be trimmed onto the chip by writing to a non-volatile memory. At the SoC runtime, those target configurations could be transferred from the non-volatile memory to a memory structure (e.g., a register) inside of the control and configuration module coupled to the adaptive voltage converter.

In some implementations, it is desirable for the adaptive voltage converter 302 to adjust configurations when the system power controller indicates that an SoC operating mode change is underway. In other cases, it is desirable to decouple the configuration change from the broader SoC. For example, consider an SoC that is transitioning from active mode (e.g., high performance active mode or low power active mode) to a sleep mode (e.g., sleep mode, deep sleep mode, or standby mode). The adaptive voltage converter may switch from a set of active mode configurations (e.g., higher voltage level, larger TON value, higher drive capability, etc.) to a set of sleep mode configurations (e.g., lower voltage level, lower TON value, lower drive capability, etc.) automatically. However, if it is detected that SoC power needs are higher than expected in sleep mode, the control and configuration module can automatically switch the configuration back to values suitable for an active mode even if the system power controller has not requested it to do so. Detection of high SoC power needs can be done using any known technique including but not limited to: buck converter pulse counting, measurement of voltage rail droop, and measurement of a voltage drop across a resistor.

Alternatively, in the same example in which an SoC is transitioning from active mode to sleep mode, the control and configuration module may elect to keep the adaptive voltage converter in an active mode configuration until it is determined that power needs have dropped and the voltage converter can safely transition to a sleep mode configuration while still providing adequate power to load circuits. Again, detection of SoC power needs can be done using any known technique.

Both the system power controller and the control and configuration blocks may be implemented as logic blocks or may be implemented as software executed on a processor.

The adaptive voltage converter 302 may be implemented as any known type of voltage converter including but not limited to a buck converter, a boost converter, a buck-boost converter, an LDO, and a switched cap converter. In some implementations, the adaptive voltage converter 302 can include multiple types of voltage converters and can switch between those types of voltage converters or can use different types of voltage converters to supply different voltage rails. In some implementations, a single adaptive voltage converter can also be architected to supply multiple voltage rail using known techniques. For example, a single inductor multiple output (SIMO) buck converter may be used.

An example of a suitable buck converter for the example voltage converter is that disclosed in U.S. Pat. No. 10,897,199 (“Buck Converter With Power Saving Mode” hereby incorporated by reference in its entirety). This patent described in greater detail buck converters that adapt to multiple power modes.

The previous discussion primarily focused on configuration changes driven by changes in SoC operating mode (standby, sleep, low power active, etc.) or changing power requirement. However, configuration changes can also be triggered by any other environmental change including battery voltage levels and ambient temperature. For example, a low battery voltage level can trigger placing the adaptive voltage converter 302 in low power operation, and a higher battery voltage level can trigger placing the adaptive voltage converter 302 in a higher power mode operation. In another example, an ambient temperature threshold can be used to place the adaptive voltage converter 302 in low power operation. If the ambient temperature is below the ambient temperature threshold, then the system power controller 304 can assume a lower noise floor and place the adaptive voltage converter 302 in low power operation. If the ambient temperature is above the ambient temperature threshold, then the system power controller 304 can assume a higher noise floor and place the adaptive voltage converter 302 in a higher power operating state.

While various embodiments of the present invention have been described above, it should be understood that they have been presented by way of example only, and not limitation. Numerous changes to the disclosed embodiments can be made in accordance with the disclosure herein, without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations, and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

Each of these embodiments and obvious variations thereof is contemplated as falling within the spirit and scope of the claimed invention, which is set forth in the following claims.

What is claimed is:

1. An adaptive voltage converter comprising:
a voltage output circuit operable to providing a voltage output at different voltage levels; and
a voltage controller coupled to the voltage output circuit, the voltage controller including a mode input receiving a power mode signal, wherein the voltage controller is operable to control the voltage output circuit to provide a voltage output specific to the received operating power mode.

2. The voltage converter of claim 1, wherein a system power controller sets the operating power mode.

3. The voltage converter of claim 1, wherein the operating power mode includes one of a standby mode, a deep sleep mode, a low power active mode, and a high performance active mode.

4. The voltage converter of claim 1, wherein the voltage output circuit is a switching converter.

5. The voltage converter of claim 1, wherein at least one tunable configuration of the voltage output circuit is adjusted according to the power mode by the voltage controller.

6. The voltage converter of claim 5, further comprising a storage device coupled to the voltage controller, the storage device storing configuration data for adjusting the tunable configuration.

7. The voltage converter of claim 5, wherein the configuration is one of a comparator trip point, a comparator offset value, a current drive capability, a power switch size, an amplifier bandwidth, an oscillator frequency, a converter type, and a converter operating mode.

8. The voltage converter of claim 1, wherein characteristic values are specific to a system on chip powered by the voltage converter.

9. The voltage converter of claim 1, wherein the voltage output circuit includes two different types of circuits for producing the voltage output.

10. The voltage converter of claim 1, wherein the power mode signal indicates a low power operation based on a pulse counting.

11. The voltage converter of claim 10, wherein the power mode signal indicates the low power operation based on the pulse counting being below a threshold.

12. The voltage converter of claim 10, wherein the power mode signal transitions from indicating the low power operation to a higher power operation based on the pulse counting being above a threshold.

13. The voltage converter of claim 1, wherein the power mode signal indicates a low power operation that the voltage output circuit operates in discontinuous conduction mode.

14. A method of operating an adaptive voltage converter comprising:
receiving, by a voltage controller of the adaptive voltage converter, a power mode signal indicating an operating power mode;
determining, by the voltage controller, a voltage level associated with the power mode signal; and
causing, by the voltage controller, a voltage output circuit of the adaptive voltage converter to provide the voltage level.

15. The method of claim 14, wherein the power mode signal is obtained from a system power controller of the adaptive voltage converter.

16. The method of claim 14, wherein the operating power mode includes one of a standby mode, a deep sleep mode, a low power active mode, and a high performance active mode.

17. The method of claim 14, wherein the voltage output circuit is a switching converter.

18. The method of claim 14, wherein at least one tunable configuration of the voltage output circuit is adjusted according to the power mode by the voltage controller.

19. The method of claim 18, wherein a storage device is coupled to the voltage controller, the storage device storing configuration data for adjusting the tunable configuration.

20. The method of claim 18, wherein the configuration is one of a comparator trip point, a comparator offset value, a current drive capability, a power switch size, an amplifier bandwidth, an oscillator frequency, a converter type, and a converter operating mode.
